(19) United States
(12) Patent Application Publication
(10) Pub. No.: US 2015/0186806 A1
(43) Pub. Date: Jul. 2, 2015

(54) PATTERN-BASED ANALYSIS RECOMMENDATION

(71) Applicant: International Business Machines Corporation, Armonk, NY (US)

(72) Inventors: Jason Hiltz-Laforge, Ottawa (CA); Robert Y. Nonez, Ottawa (CA); Alireza Pourshahid, Ottawa (CA); Graham A. Watts, Ottawa (CA)

(73) Assignee: International Business Machines Corporation, Armonk, NY (US)

(21) Appl. No.: 14/144,456

(22) Filed: Dec. 30, 2013

(51) Int. Cl. G06Q 10/06; G06K 9/62; G06K 9/20; G06F 17/30

(52) U.S. Cl. CPC G06Q 10/063; G06F 17/3028; G06K 9/6202; G06K 9/6215; G06K 9/2081

(57) ABSTRACT

A computing system includes at least one processor and at least one module operable by the at least one processor to receive input data, and determine, based at least in part on the input data, a plurality of visualizations, each of the plurality of visualizations representing at least a portion of the input data. The at least one module is further operable to determine a respective score for each of the plurality of visualizations, the respective score for each visualization from the plurality of visualizations being based at least in part on a comparison of the corresponding visualization to one or more visual patterns, determine, based at least in part on the respective score for each of the plurality of visualizations, an ordering of the plurality of visualizations, and output, for display, at least one visualization from the plurality of visualizations in accordance with the ordering.

### FIELD OF INVENTION

This disclosure relates to techniques for generating reports in an enterprise software system.

### BACKGROUND

Enterprise software systems are typically sophisticated, large-scale systems that support many, e.g., hundreds or thousands, of concurrent users. Examples of enterprise software systems include financial planning systems, budget planning systems, order management systems, inventory management systems, sales force management systems, business intelligence tools, enterprise reporting tools, project and resource management systems, and other enterprise software systems.

Many enterprise performance management and business planning applications acquire data entered from a large base of users that the software then accumulates into higher-level areas of responsibility in the organization. Often these systems make use of multidimensional data sources that organize and manipulate the large volume of data using data structures referred to as data cubes. A data cube may, for example, include a plurality of hierarchical dimensions having levels and members for storing the multidimensional data. Once data has been entered, a user may wish to view some or all of the data in a coherent manner by generating a report. The system may perform mathematical calculations on the data and combine data submitted by many users. Using the results of these calculations, the system may generate reports for review.

The use of reporting and analysis end-user products (typically referred to as Business Intelligence, or BI, tools) allows users to author reports and perform data exploration and analysis on a myriad of data sources, such as multidimensional data structures, relational databases, flat files, Extensible Markup Language (“XML”) data, data streams, and unorganized text and data. Business intelligence tools may be used to prepare and aggregate individual reports and analyses by executing queries on underlying data sources and to present those reports and analyses in a user-accessible format.

### SUMMARY

In one example, a method includes receiving, by a computing device comprising at least one processor, input data, determining, by the computing device and based at least in part on the input data, a plurality of visualizations, each of the plurality of visualizations representing at least a portion of the input data, and determining, by the computing device, a respective score for each of the plurality of visualizations, the respective score for each visualization from the plurality of visualizations being based at least in part on a comparison of the corresponding visualization to one or more visual patterns. The method may further include determining, by the computing device and based at least in part on the respective score for each of the plurality of visualizations, an ordering of the plurality of visualizations, and outputting, by the computing device and for display, at least one visualization from the plurality of visualizations in accordance with the ordering.

In another example, a computing system includes at least one processor and at least one module operable by the at least one processor to receive input data, and determine, based at least in part on the input data, a plurality of visualizations, each of the plurality of visualizations representing at least a portion of the input data. The at least one module may be further operable to determine a respective score for each of the plurality of visualizations, the respective score for each visualization from the plurality of visualizations being based at least in part on a comparison of the corresponding visualization to one or more visual patterns, determine, based at least in part on the respective score for each of the plurality of visualizations, an ordering of the plurality of visualizations, and output, for display, at least one visualization from the plurality of visualizations in accordance with the ordering.

In another example, a computer program product comprising a computer readable storage medium having program code embodied therewith, the program code executable by at least one processor to receive input data, determine, based at least in part on the input data, a plurality of visualizations, each of the plurality of visualizations representing at least a portion of the input data, and determine a respective score for each of the plurality of visualizations, the respective score for each visualization from the plurality of visualizations being based at least in part on a comparison of the corresponding visualization to one or more visual patterns. The program code may be further executable to determine, based at least in part on the respective score for each of the plurality of visualizations, an ordering of the plurality of visualizations, and output, for display, at least one visualization from the plurality of visualizations in accordance with the ordering.

The details of one or more examples are set forth in the accompanying drawings and the description below. Other features will be apparent from the description and drawings, and from the claims.

### BRIEF DESCRIPTION OF DRAWINGS

FIG. 1 is a block diagram illustrating an example computing environment in which a plurality of users interact with an enterprise business intelligence system, in accordance with one or more aspects of the present disclosure.

FIG. 2 is a block diagram illustrating one example of a computing device that may interact with the enterprise business intelligence system of FIG. 1, in accordance with one or more aspects of the present disclosure.

FIG. 3 is a block diagram illustrating one example of an analysis recommendation module, in accordance with one or more aspects of the present disclosure.

FIG. 4 is a block diagram illustrating operations and a graphical user interface (GUI) for providing ordered recommendations based on visual patterns, in accordance with one or more aspects of the present disclosure.

FIG. 5 is a flowchart illustrating example operations of a computing device for providing recommendations based on visual patterns, in accordance with one or more aspects of the present disclosure.

### DETAILED DESCRIPTION

The increase in the volume, velocity, and variety of data has made analysis of data both a potentially important and challenging task for businesses and data analysts. Business users at all levels may now often be expected to perform data analysis in order to have a higher impact on the business and perform better in their responsibilities. Although data analysis is becoming a widespread activity, the skill set to perform such data analysis may not be as easy to gain, and the learning curve can be steep.

Such volume and variety of data may also increase the number of possible types of analysis and particular visualizations that can be performed on a set of data. That is, for a given set of data, there may be numerous visualizations possible, all having potential benefits and drawbacks in various situations. Users may benefit not only from tools to suggest types of visualizations or analyses for certain types of data, but also from tools to assist in determining visualizations or analyses that provide interesting or useful information based on patterns within the data itself.

Techniques of the present disclosure enable a computing device (e.g., a desktop or laptop computer, a server system or computing “cloud,” a mobile device, smartphone, or other device) to use a library of patterns to rank analysis types and/or visualizations in order of predicted importance to the user. By recognizing patterns within a data set and recommending visualizations that show those patterns, the techniques described herein may potentially help users to avoid getting lost in the thousands of possible visualizations (e.g., of various analysis types) that can be generated and instead focus on the visualizations that matter most to the business. That is, the techniques described herein may provide visual pattern-based recommendation by prioritizing types of analysis and/or specific visualizations based on visual patterns that may be recognized in a given data set.

In some aspects, techniques of the present disclosure may allow users to define custom visual patterns or specific focus areas of interest. That is, a user may define a certain type of measure or analysis type that should be prioritized over other insightful visualizations and/or add custom visual patterns to the pattern library to receive recommendations of visualizations that meet certain criteria. As such, users may potentially be able to more easily create reports that include relevant or interesting visualizations of the data set. By providing recommendations based on similarity to visual patterns, computing devices employing the techniques described herein may make it easier for users to find the visualizations that include an insightful depiction of the data.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, a system, apparatus, or device used to store data, but does not include a computer readable signal medium. Such system, apparatus, or device may be of a type that includes, but is not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of

a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

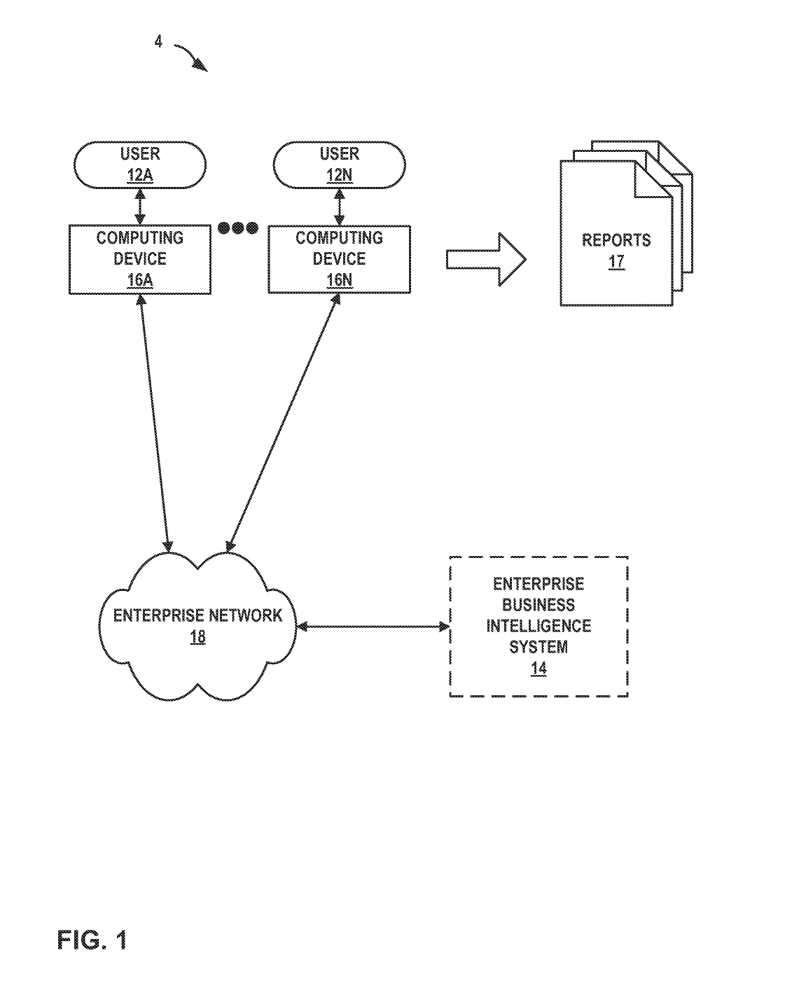

FIG. 1 is a block diagram illustrating an example computing environment (e.g., enterprise 4) in which a plurality of users 12A-12N (collectively “users 12”) may interact with an enterprise business intelligence system 14, in accordance with one or more aspects of the present disclosure. As shown in the example system of FIG. 1, enterprise business intelligence system 14 may be communicatively coupled to a number of computing devices 16A-16N (collectively “computing devices 16”) via enterprise network 18. Users 12 interact with their respective computing devices to access enterprise business intelligence system 14 in order to input, modify, and review data. In one example, users 12 may use computing devices 16 to access enterprise business intelligence system 14 and author one or more reports 17. Reports 17 may include business intelligence reports, such as sales reports, revenue reports, payroll reports, and the like. Enterprise business intelligence system 14 may provide users 12 with functionality to create or define a structure for reports 17 using report specifications and/or queries. Computing devices 16A-16N, enterprise network 18, and enterprise business intelligence system 14 may all be either in a single facility or widely dispersed in two or more separate locations anywhere in the world, in different examples.

For purposes of illustration only, various techniques of the present disclosure are described with respect to generation of reports and/or report specifications. However, certain examples of the techniques of this disclosure may be readily applied to various software systems executed by various devices, including enterprise business intelligence systems, other large-scale enterprise software systems, as well as single-user and/or stand-alone software applications. Examples of enterprise software systems include enterprise financial or budget planning systems, order management systems, inventory management systems, sales force management systems, business intelligence tools, enterprise reporting tools, project and resource management systems, and other enterprise software systems. Other example applications include graphical design applications, spreadsheet applications, financial applications, or other applications in which users may benefit from visual pattern-based analysis to determine visualizations for a report. For instance, various techniques of this disclosure may be readily applied by computing devices for reviewing financial asset performance.

In the example of FIG. 1, users 12 may interact with a user-configurable business intelligence user interface (UI) to view and manipulate data (e.g., generate reports 17) via their respective computing devices 16. This may include data from any of a wide variety of sources, including from multidimensional data structures and relational databases within enterprise 4, as well as data from a variety of external sources that may be accessible over a public network. Multidimensional data structures are “multidimensional” in that each multidimensional data element is defined by a plurality of different object types, where each object is associated with a different dimension. Users 12 may, for example, retrieve data related to store sales by entering a name of a sales person, a store identifier, a date, a product, and a price at which the product was sold, into their respective computing devices 16.

Enterprise users 12 may use a variety of different types of computing devices 16 to utilize a business intelligence UI and to generate business intelligence reports 17 or otherwise interact with enterprise business intelligence system 14 via enterprise network 18. For example, an enterprise user 12 may utilize a business intelligence UI and interact with enterprise business intelligence system 14 using a laptop computer, desktop computer, or the like, which implements a web browser. Alternatively, an enterprise user 12 may use a smartphone or similar device, utilizing a business intelligence UI in either a web browser or a dedicated mobile application for interacting with enterprise business intelligence system 14. Further examples of computing devices 16 may include workstation computers, netbooks, tablet computers, E-readers, or any other such computing device. In either case, a business intelligence UI running on a user's computing device 16 may access various data sources from within enterprise business intelligence system 14, as well as any of a variety of external network resources and any of a variety of external data sources.

Enterprise network 18 may represent any communication network, such as a packet-based digital network like a private enterprise intranet or a public network like the Internet. In this manner, enterprise network 18 can readily scale to suit large enterprises. Enterprise users 12 may directly access enterprise business intelligence system 14 via a local area network, or may remotely access enterprise business intelligence system 14 via a virtual private network, remote dial-up, or similar remote access communication mechanism.

The business intelligence UI running on a user's computing device 16 may use retrieved data to generate one or more reports 17. Reports 17 may include any visual representation or depiction of data such as tables, charts, graphs, or other methods of disseminating information. For example, reports 17 may include a graph with sales values assigned to a vertical axis, and time values assigned to a horizontal axis, a chart of revenue values recorded for various sales regions, a table of payroll data values recorded for different enterprise locations, a graph of enterprise spending by department, and the like. Users 12 may interact with computing devices 16 to generate reports 17 by selecting different data elements and/or dimensions to display in visualizations for reports 17.

Reports 17 may be generated based on report specifications. Generally, report specifications may determine the type, layout, quantity, categories, or other characteristics of data elements included in reports 17. That is, report specifications may be a configuration of the data elements to be included in one or more visualizations for reports 17. Examples of report specifications may include a document used by one of computing devices 16 to generate a graphical pie chart depicting the desired data elements, a bar graph displaying various categories of the desired data elements, a crosstab displaying values for intersecting dimensions, or other representations of the data elements.

For a given data set, there may be many possible report specifications for visualizing the data, all having their own benefits and drawbacks relative to one another. When choosing a visualization for reports and analyses, a user may have minimal knowledge of the included data and/or the different types of visualizations and analyses available. For example, a set of data containing product sales amounts for multiple retail locations over a fiscal year may be represented as a line chart, a bar chart or a pie chart within one of reports 17. A pie chart may be considered a poor choice in some instances, such as when each store performed relatively similarly when considering overall sales for the fiscal year. In contrast, a line chart showing individual retail locations may be a better choice, as it may show an interesting steady decline in sales for a particular location. In another example, the sales amounts for each retail location may remain relatively constant, and individual line charts may not provide interesting insight. However, a particular store may have significantly outperformed all the others throughout the fiscal year. In this instance, the pie chart may be more interesting to business users as it shows the significant difference in yearly sales.

In order to assist in determining and generating interesting and/or insightful reports 17, the business intelligence UI running on computing devices 16 may be able to process a data set using a library of visual patterns to rank informative visualizations. One of computing devices 16 may receive input data and determine a plurality of possible visualizations of the input data (e.g., using template-driven techniques or other techniques). The computing device may compare each of the plurality of possible visualizations to visual patterns contained in the library. Based at least in part on the comparisons, the computing device may determine a respective score for each of the plurality of possible visualizations and determine an ordering of the plurality of possible visualizations based at least in part on the scores. Finally, the computing device may output, for display, at least one visualization from the plurality of possible visualizations in accordance with the ordering. That is, in some examples the computing device may output a single visualization (e.g., the top visualization), while in other examples, the computing device may output at least two visualizations (e.g., the top three visualizations, the top five visualizations, and so on).

By comparing possible visualizations to a number of possible patterns, techniques of the present disclosure may assist business users in creating reports that provide better insight into business activities and other important focus areas. Furthermore, by allowing users to define custom visual patterns or specific focus areas of interest, techniques described herein may be customizable to help users obtain recommendations of visualizations that are important to a specific user or a specific business.

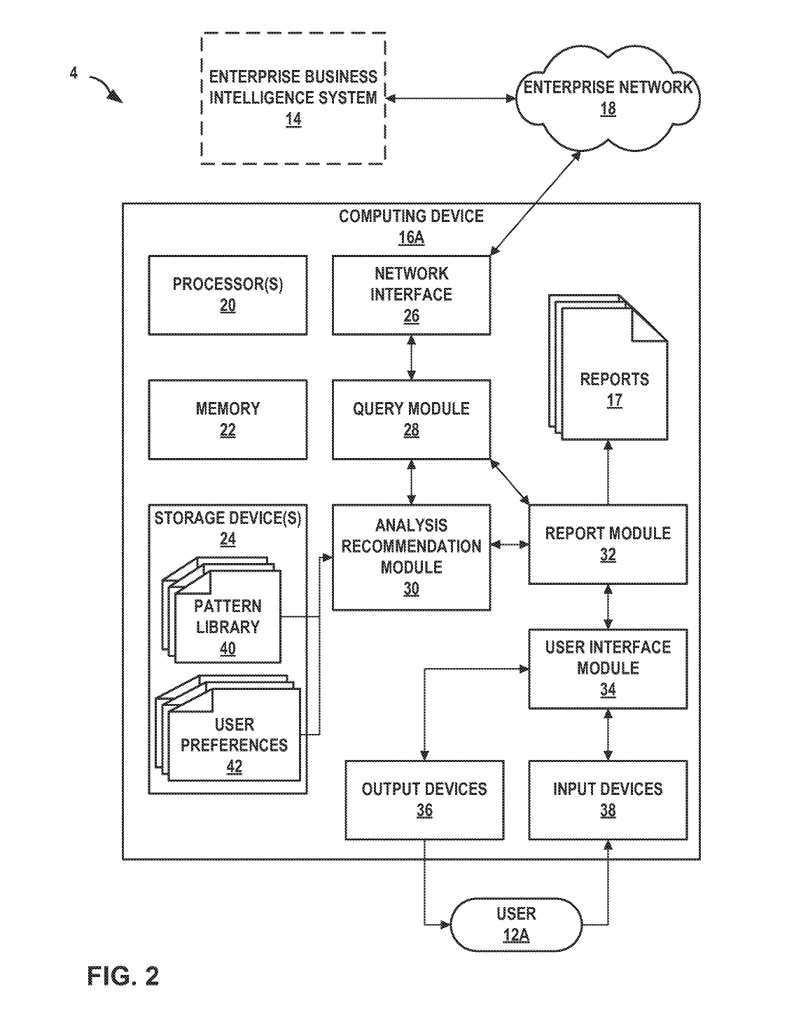

FIG. 2 is a block diagram illustrating one example of a computing device 16A that may interact with the enterprise business intelligence system 14 of FIG. 1, in accordance with one or more aspects of the present disclosure. In the example of FIG. 2, computing device 16A includes one or more processors 20, memory 22, and one or more storage devices 24. In addition, computing device 16A includes network interface 26, query module 28, analysis recommendation module 30, report module 32, user interface (UI) module 34, one or more output devices 36, and one or more input devices 38. While shown as separate components in FIG. 2, operations performed by one or more of network interface 26, modules 28, 32 34, as well as analysis recommendation module 30 and/or devices 36 and 38 may be performed by a single module or device, or other number of modules or devices in various examples.

In some examples, one or more components shown in the example of FIG. 2, such as query module 28, analysis recommendation module 30, and/or report module 32 may be part of enterprise business intelligence system 14 or other device of enterprise 4 (e.g., connected to enterprise network 18). Additionally, while pattern library 40 and user preferences 42 are shown in the example of FIG. 2 as being stored at computing device 16A, pattern library 40 and/or user preferences 42 may, in other examples, be stored in one or more storage devices of enterprise business intelligence system 14, or any other device of enterprise 4. That is, while described with respect to FIG. 2 as being performed by one or more components of computing device 16A, techniques of the present disclosure may be performed by enterprise business intelligence system 14 or any other device of enterprise 4.

Processors 20, as shown in the example of FIG. 2, may be configured to implement functionality and/or process instructions for execution in computing device 16A. For instance, processors 20 may be capable of executing instructions of various components of computing device 16A, such as modules 28, 32 and 34, and/or analysis recommendation module 30. Examples of processors 20 may include, any one or more of a microprocessor, a controller, a digital signal processor (DSP), an application specific integrated circuit (ASIC), a field-programmable gate array (FPGA), or equivalent discrete or integrated logic circuitry.

In the example of FIG. 2, memory 22 may be one or more memory units configured to store information in computing device 16A during operation. For instance, memory 22 may be usable to store program instructions for execution by processors 20 and/or may be usable by software or applications running on computing device 16A (e.g., modules 28, 32, 34, and/or analysis recommendation module 30) to temporarily store information during program execution. In some examples, memory 22 may be a temporary memory, meaning that a primary purpose of memory 22 is not long-term storage. In other examples, memory 22 may include one or more computer-readable storage media suitable for long-term data storage. Memory 22 may, in some examples, be described as volatile memory, meaning that memory 22 does not maintain stored contents when the computing device is turned off. Examples of volatile memories include random access memories (RAM), dynamic random access memories (DRAM), static random access memories (SRAM), and other forms of volatile memories known in the art.

Storage devices 24, as shown in the example of FIG. 2, may include one or more computer-readable storage media. Storage devices 24 may be configured to store larger amounts of information than volatile memory. Storage devices 24 may further be configured for long-term storage of information. In some examples, storage devices 24 include non-volatile storage elements. Examples of non-volatile storage elements include magnetic hard discs, optical discs, floppy discs, flash memories, or forms of electrically programmable memories (EPROM) or electrically erasable and programmable memories (EEPROM). In the example of FIG. 2, storage devices 24 may store pattern library 40 and user preferences 42 for use during operation of computing device 16A. In some examples, such as during operation, pattern library 40 and/or user preferences 42 may be stored in memory 22 instead of, or in addition to being stored in storage devices 24. In other words memory 22 and storage devices 24 may, in some examples, be similar or interchangeable components.

In the example of FIG. 2, storage devices 24 contain pattern library 40 and user preferences 42. Pattern library 40 may store one or more pre-defined visual patterns for use in predicting useful or interesting visualizations for reports 17. For instance, to name only a few illustrative examples, pattern library 40 may include visual patterns corresponding to a “spike” or “dip” in a line chart, an upward trend in a line chart, a significant difference in contribution from one category in a stack chart, a cluster of items in a correlation chart, or other visual patterns. User preferences 42 may, in some examples, contain additional visual patterns defined by users of computing device 16A and/or users within enterprise 4 (e.g., administrators). User preferences 42 may also include focus areas defined by users, such as categories, measures, or metrics based on meta-data in a data set. For instance, user 12A of computing device 16A may define corporate profits or geographic regions as focus areas. When a focus area is defined, techniques of the present disclosure may prioritize visualizations that display the defined focus area or provide useful insight into the defined focus area. In some examples, user preferences 42 may include a ranking or selection of the pre-defined visual patterns contained in pattern library 40. That is, user preferences 42, in some examples, may specify which patterns in pattern library 40 should be used or which patterns should be prioritized over others.

In some examples, memory 22 and/or storage devices 24 may also include one or more data cubes. Data cubes may store data obtained from user 12A and/or obtained from data sources of enterprise business intelligence system 14 via enterprise network 18. Data stored in the data cubes may provide the underlying data for computing device 16A to define report specifications and/or create reports 17. Data cubes, in some examples, may include data from two-dimensional databases and/or multidimensional databases. Data cubes may be implemented using a variety of vendor platforms, and may be distributed throughout the enterprise via network interface 26. As one example, the data cubes may include data from multidimensional databases configured for Online Analytical Processing (OLAP). As another example, the data cubes may include data from multidimensional databases configured to receive and execute Multidimensional Expression (MDX) queries of some arbitrary level of complexity. As yet another example, the data cubes may include data from two-dimensional relational databases configured to receive and execute SQL queries, also with an arbitrary level of complexity. Storing the data cubes locally within memory 22 and/or storage devices 24 may allow some or all calculation performed as part of defining report specifications and generating reports 17 to be performed locally by computing device 16A. In other examples, computing device 16A may not store the data cubes locally, and one or more devices, such as enterprise business intelligence system 14 may perform the calculation.

In the example of FIG. 2, network interface 26 of computing device 16A may provide functionality to communicate with external devices, such as enterprise business intelligence system 14, via one or more networks (e.g., enterprise network 18). Examples of network interface 26 may include a network interface card, such as an Ethernet card, an optical transceiver, a radio frequency transceiver, or any other type of device that can send and receive information. Other examples of such network interfaces may include 3G and WiFi radio components, as well as Universal Serial Bus (USB). In some examples, computing device 16A utilizes network interface 26 to communicate with enterprise business intelligence system 14 when sending or receiving multidimensional data, such as when retrieving data for reports 17.

Query module 28, as shown in the example of FIG. 2, may include instructions operable by processors 20 via memory 22 to generate queries used to obtain data from enterprise business intelligence system 14 via enterprise network 18. For instance, query module 28 may receive a request (e.g., from report module 32 or user 12A) to generate one or more queries for a set of data or specific data elements within multidimensional data of enterprise 4. In some examples, query module 28 may generate one or more queries and retrieve relevant enterprise data from locally stored data cubes (e.g., stored on storage devices 24 and/or memory 22). In other examples, query module 28 may retrieve relevant data from data cubes of enterprise business intelligence system 14 (e.g., via network interface 26). In any case, the results of queries performed by query module 28 may be sent to other components associated with computing device 16A, such as report module 32 or analysis recommendation module 30.

In the example of FIG. 2, report module 32 may include instructions operable by processors 20 via memory 22 to generate reports 17 based on report specifications. Report specifications may be one or more documents used by computing device 16A (e.g., stored on storage devices 24) that provide the structure and content of reports 17. In some examples, report specifications may include documents or files containing markup language (e.g., XML) instructions defining various criteria for a report. That is, report specifications may be configurations of data (e.g., input data) to be included in a report. For instance, a report specification may define the layout of various charts and tables to be displayed in a report. Report specifications may include one or more definitions specifying which data element or elements are to be included in parts of reports 17. The definitions within the report specifications may be created in a query language, (e.g., SQL), and may be executable by components of computing device 16A to cause retrieval of the defined data elements from underlying data sources. As one example, a definition may be interpreted by report module 32 to generate a report including a line graph, cause the report to include all data elements belonging to a particular hierarchy, and cause the report to display markers for each included data point in the line graph.

Report module 32 may, in some examples, communicate with analysis recommendation module 30 to cause analysis recommendation module 30 to generate visualizations in accordance with one or more techniques of the present disclosure. For instance, report module 32 may send a request to analysis recommendation module 30 providing input data (e.g., a data set) and receive one or more configurations of at least a portion of the data set (e.g., potential visualizations) for inclusion in one or more reports 17. Report module 32 may provide the potential visualizations to UI module 34. UI module 34 may output a GUI (e.g., at output devices 36) displaying one or more potential visualizations for consideration by user 12A. UI module 34 may receive an indication of a selection of a potential visualization (e.g., at one of input devices 38) and send the indication to report module 32. Report module 32 may provide the indication to analysis recommendation module 30, receive a corresponding report specification for the selected visualization, and generate one or more of reports 17 based on the received report specification. In the example of FIG. 2, report module 32 outputs reports 17 locally at computing device 16A. In other examples, report module 32 may output reports 17 to enterprise business intelligence system 14, or to others of computing devices 16 via network interface 26.

UI module 34 may, in the example of FIG. 2, include instructions operable by processors 20 via memory 22 to interact with output devices 36 and/or input devices 38 to provide an interface to user 12A. The interface provided by UI module 34 may enable selection of a data set from the multidimensional enterprise data and/or creation of one or more reports 17. That is, UI module 34 may display a GUI (e.g., at one or more of output devices 36) with which user 12A can interact (e.g., by using one or more of input devices 38) to cause computing device 16A to create report specifications and/or generate reports 17.

UI module 34 may output information to user 12A via one or more of output devices 36 operatively coupled to computing device 16A. Output devices 36, in some examples, are configured to provide output to a user using tactile, audio, or video stimuli. Output devices 36 may include a presence-sensitive display, a sound card, a video graphics adapter card, or any other type of device for converting a signal into an appropriate form understandable to humans or machines. Additional examples of output devices 36 include a speaker, a cathode ray tube (CRT) monitor, a liquid crystal display (LCD), or any other type of device that can generate intelligible output to a user. UI module 34 may receive input from user 12A via one or more input devices 38. Input devices 38 may be part of computing device 16A, or may be communicatively coupled to computing device 16A. Input devices 38 may include a keyboard, a mouse, a touch-sensitive or presence-sensitive display, a stylus, or any device operable to provide machine input.

In the example of FIG. 2, analysis recommendation module 30 may include instructions operable by processors 20 via memory 22 to receive input from other components of computing device 16A (e.g., from one or more of modules 28, 32, and 34) and output a plurality of ordered visualizations. In examples where analysis recommendation module 30 is contained in other devices, analysis recommendation module 30 may receive requests and output recommendations via enterprise network 18. In one example, analysis recommendation module 30 may receive a request from report module 32 for recommended visualizations. The request may be accompanied by a specified set of data elements (e.g., as specified by user 12A). Analysis recommendation module 30 may include instructions operable by processors 20 via memory 22 to determine one or more configurations (e.g., visualizations) that provide insight into data elements included in the data set and may provide the visualizations to report module 32. That is, analysis recommendation module 30 may receive a data set as input, determine one or more visualizations based on the received data set, and output ordered visualizations (e.g., as visualizations, as data describing the visualizations, or in other formats) to report module 32.

In order to determine the order of the recommended visualizations, analysis recommendation module 30 may utilize pattern library 40 and/or user preferences 42. For instance, after receiving a request for recommendations from report module 32, analysis recommendation module 30 may determine one or more possible visualizations based on the data set accompanying the request. Some possible visualizations may include the entire data set, while other visualizations may include a portion of the data (e.g., a single category of data, a single series of data, or another portion of the data set). Analysis recommendation module 30 may then compare the possible visualizations to the visual patterns included in pattern library 40 and/or visual patterns included in user preferences 42. Analysis recommendation module 30 may determine a score for each of the possible visualizations based at least in part on how closely the visualization matches one or more of the visual patterns. That is, visualizations that closely match one or more visual patterns may receive a higher score than visualizations that do not closely match any of the visual patterns.

In some examples, when determining the score for the possible visualizations, analysis recommendation module 30 may also take into account focus areas defined in user preferences 42. Those visualizations that display defined focus areas may be scored higher than those visualizations that do not display a defined focus area. In any case, analysis recommendation module 30 may determine an ordering for the visualizations based on the determined scores and output the visualizations (e.g., to report module 32) in accordance with the ordering. In some examples, analysis recommendation module 30 may output a single visualization (e.g., corresponding to the visualization having the best score). In other examples, analysis recommendation module 30 may output a plurality of visualizations in accordance with the ordering.

Report module 32 may receive the ordered set of visualizations from analysis recommendation module 30 and provide the visualizations to user 12A for selection. That is, report module 32 may communicate with UI module 34 to display one or more of the ordered set of visualizations at one or more of output devices 36. User 12A may review the presented options and select a desired visualization. Report module 32 may receive the selection, and send an indication of the selection to analysis recommendation module 30. Analysis recommendation module 30 may receive the indication, and provide report module 32 with a report specification that corresponds to the selected visualization. Report module 32 may then generate the desired report (e.g., one of reports 17) based on the received report specification.

In some examples, computing device 16A may perform techniques of the present disclosure without requiring input from user 12A. That is, analysis recommendation module 30 may be operable to generate and output a report specification that report module 32 may use to generate one of reports 17. In such instance, user 12A may not take any action to select a visualization, as the visualization having the highest determined score is used. In other words, if report module 32 sends a request to analysis recommendation module 30 for immediate output, analysis recommendation module 30 may automatically choose the visualization having the highest score, and output the corresponding report specification.

By determining an ordering of recommended visualizations based on visual pattern matching, analysis recommendation module 30 may enable computing device 16A to assist users in creating reports that show interesting or valuable aspects of a data set. That is, one or more techniques of the present disclosure may provide a pattern-based, user-customizable framework for causing a computing device to assist in the creation of visualizations and reports based on visual similarities between potential visualizations and defined visual patterns.

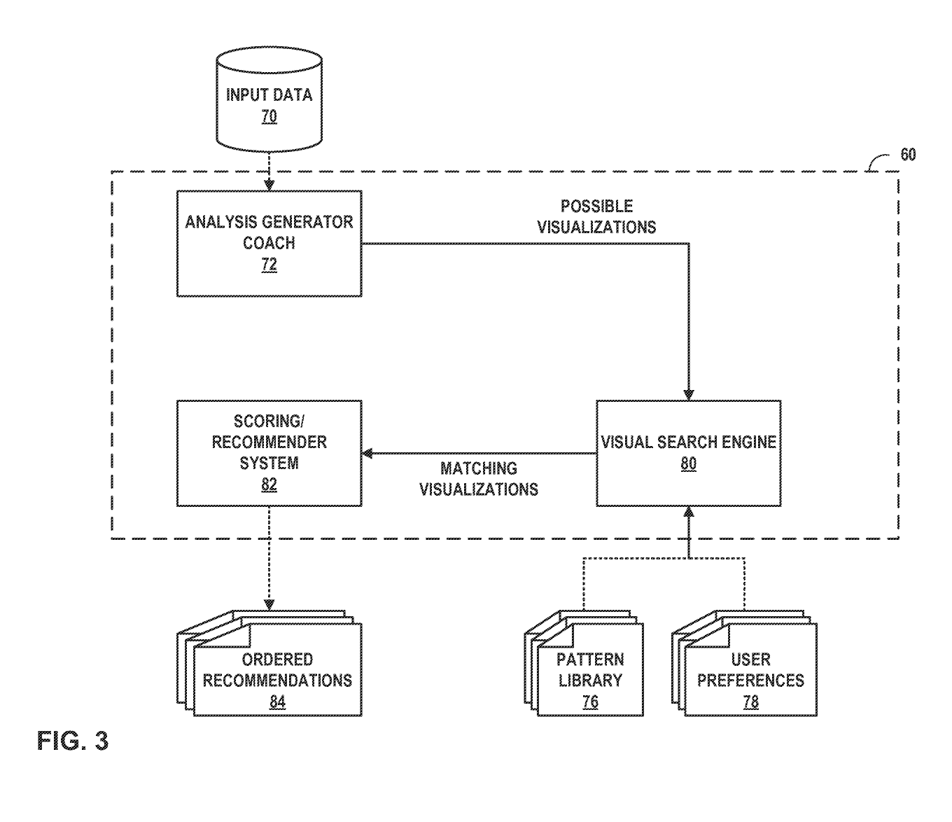

FIG. 3 is a block diagram illustrating one example of analysis recommendation module 60, in accordance with one or more aspects of the present disclosure. The example of FIG. 3 is described below within the context of FIGS. 1 and 2. For instance, analysis recommendation module 60 of FIG. 3 may represent one example of analysis recommendation module 30 as shown in FIG. 2. In some examples, analysis recommendation module 60 may include additional or alternative functionality.

In the example of FIG. 3, analysis recommendation module 60 may receive input data 70. Input data 70 may include any number of data elements corresponding to various types of information. For instance, input data 70 may be all the data from a business for the previous fiscal year. That is, input data 70 may include sales information, purchase information, payroll information, investment information, and other information. Each data element may include various dimensions such as an employee dimension for payroll data, a store location dimension for sales data, a vendor dimension for purchase information, and other dimensions. Other examples of input data 70 may be or may include historical performance information for a number of stocks on the stock market, grading information for students, results from a number of lab experiments, or any other information.

Analysis recommendation module 60 may, in the example of FIG. 3, provide input data 70 to analysis generator coach 72. Analysis generator coach 72 may be operable to analyze the input data to determine possible visualization types and/or possible visualizations. For instance, analysis generator coach 72 may be able to read one or more templates for configuring input data and determine the criteria to be satisfied in order to resolve the template(s), as well as the various ways those criteria can be satisfied. Analysis generator coach 72 may then create a set of potential resolutions of the templates.

As one non-limiting example, analysis generator coach 72 may determine what types of visualizations can be determined from input data 70 by comparing various data elements and dimensions to templates for a number of visualization types. For instance, analysis generator coach 72 may determine potential pie chart visualizations having wedges that represent sales values for each customer, each store, each month, each product or other dimension. Analysis generator coach 72 may determine potential line chart visualizations in which payroll data is tracked over time, in which sales data is tracked over time, in which particular vendor purchases are tracked over time, or other potential line chart visualizations. Analysis generator coach 72 may determine a number of other potential visualizations of at least a portion of input data 70. In some examples, analysis generator coach 72 may not determine line chart visualizations having payroll data tracked over employee, as a template for line charts may require the X-axis to correspond to a temporal dimension (e.g., days, months, years, etc.). In some examples, analysis generator coach 72 may have no information regarding the input, any outputs, or rules. That is, analysis generator coach 72 may execute on the input data using the rules described in the templates in order to produce potential outputs. In other examples, analysis generator may be more specialized to handle certain types of input data or produce certain types of outputs.

In the example of FIG. 3, analysis generator coach 72 may send information to visual search engine 80 that includes at least an indication of possible visualizations. In some examples, analysis generator coach 72 may send generated visualizations (e.g., charts, tables, or other graphics). In other examples, analysis generator coach 72 may send data defining a visualization (e.g., a report specification), data defining what parts of input data 70 to include, or any other information that specifies a set of data.

Visual search engine 80, in the example of FIG. 3, may be operable to receive possible visualizations, and compare the visualizations to visual patterns stored in pattern library 76 and/or in user preferences 78. That is, visual search engine 80 may access visual patterns stored within pattern library 76 (e.g., at storage devices 24) and/or within user preferences 78, and perform operations to compare the visual patterns to the received visualizations.

In some examples, such as examples in which visual search engine 80 receives generated visualizations from analysis generator coach 72, visual search engine 80 may operate to compare two visual data files. For instance, visual search engine 80 may perform various image comparison techniques to determine which of the received possible visualizations are visually similar to the visual patterns. In other examples, such as examples in which visual search engine 80 receives data indicating a visualization or data (e.g., parts of input data 70) from analysis generator coach 72, visual search engine 80 may operate to compare two data files. For instance, visual search engine 80 may perform a mathematical comparison between a sequence of data values in a visual pattern and data values in the received potential visualizations.

For each comparison between a possible visualization and a visual pattern, visual search engine 80 may obtain a value indicating the similarity between the items being compared. That is, by comparing a visualization to a visual pattern, visual search engine 80 may obtain an indicator of how visually similar the visualization is to the visual pattern. In some examples, the indicator may a percentage score or other value measured on a scale (e.g., a scale of 0-100 or the like). In other examples, the indicator may be a relative or normalized value. That is, visual search engine 80 may determine, for each possible visualization, a similarity between the possible visualization and each visual pattern from pattern library 76 and/or user preferences 78. Visual search engine 80 may then normalize each similarity value against the best similarity value.

As one non-limiting example of comparing a possible visualization and a visual pattern, visual search engine 80 may receive, as possible visualizations, information describing two bar graphs, each containing four categories (e.g., four bars). The bars of the first possible visualization may have values of 4.00, 2.00, 3.00, and 4.00. The bars of the second visualization may have values of 2.00, 6.00, 3.00, and 1.00. Visual search engine 80 may access pattern library 76 and obtain the set of visual patterns. In this example, pattern library 76 may contain only one applicable visual pattern. That is, pattern library 76 may contain only one visual pattern that represents a bar graph.

The bar graph visual pattern may have four bars with the values of 4.25, 2.50, 3.50, and 4.50. In order to determine similarities between each possible visualization and each visual pattern, visual search engine 80 may compare the values of the first possible visualization to the values of the visual pattern. In some examples, prior to the comparison, visual search engine 80 may normalize the values (e.g., to match the pattern no matter the values). In other examples, visual search engine 80 may not normalize the values (e.g., to match a pattern of specific values). In the present example, visual search engine 80 may not normalize the values, and may determine the similarity by determining the average percent of difference between two sets of data. That is, to compare the possible visualizations and the visual pattern, visual search engine 80 may determine the percent difference between respective bars, and then average the percent differences by the number of bars. For the first possible visualization, visual search engine 80 may determine a similarity value of

$$\frac{( \frac{4.00}{4.25} ) + ( \frac{2.00}{2.50} ) + ( \frac{3.00}{3.50} ) + ( \frac{4.00}{4.50} )}{4} ≅ \frac{0.94 + 0.80 + 0.86 + 0.89}{4} ≅ 0.87 .$$

For the second possible visualization, visual search engine 80 may determine a similarity value of

$$\frac{( \frac{2.00}{4.25} ) + ( \frac{2.50}{6.00} ) + ( \frac{3.00}{3.50} ) + ( \frac{1.00}{4.50} )}{4} ≅ \frac{0.47 + 0.42 + 0.86 + 0.22}{4} ≅ 0.49 .$$

Visual search engine 80 may analyze resulting similarity values to determine which possible visualizations match one or more visual patterns. For instance, visual search engine 80 may determine whether each possible visualization is associated with a similarity value that meets or exceeds a threshold value. In the non-limiting example of the two possible visualizations above, the threshold value may be 0.70. Thus, visual search engine 80 may determine that the first possible visualization, associated with a similarity value of 0.87, matches the visual pattern. Visual search engine 80 may determine that the second possible visualization, associated with the similarity value of 0.49, does not match the visual pattern. In this way, visual search engine 80 may determine which possible visualizations match one or more visual patterns.

In some examples, visual search engine 80 may additionally or alternatively determine whether one or more of the possible visualizations are related to one or more focus areas defined by user preferences 78. For instance, visual search engine 80 may determine whether or not a possible visualization includes data of a type specified by a focus area, includes data of a value specified by a focus area (e.g., data recorded within a certain time period), or otherwise relates to the focus area. For example, user preferences 78 may define sales values as a focus area. Visual search engine 80 may additionally or alternatively determine possible visualizations that include sales data as matching visualizations.

Visual search engine 80, in the example of FIG. 3, may output matching visualizations to scoring/recommender system 82. Matching visualizations may include the visualizations themselves, as well as associated data, such as one or more similarity values, one or more indications of focus areas, or other information. In some examples, only those visualizations having a threshold similarity value may be output as matching visualizations. In other examples, all possible visualizations may be output as matching visualizations, along with corresponding similarity values.

In the example of FIG. 3, scoring/recommender system 82 may be operable to receive matching visualizations and associated data, score the received visualizations based on the associated data, and determine an ordering of the visualizations. That is, scoring/recommender system 82 may score the received visualizations based on similarity values associated with each visualization and/or focus areas associated with each visualization. As one example, scoring/recommender system 82 may take the sum of all similarity values associated with a particular visualization, and multiply the sum by the number of focus areas associated with the particular visualization to determine a score for the particular visualization. In general, scoring/recommender system 82 may score visualizations that are associated with a focus area higher than those visualizations not associated with a focus area. Scoring/recommender system 82 may also score visualizations that are associated with high similarity values higher than those visualizations associated with low similarity values. In this way, scoring/recommender system 82 may prioritize those visualizations that are similar to one or more visual patterns and/or those visualizations that relate to the defined focus areas.

Based on the scores for the matching visualizations, scoring/recommender system 82 may order the visualizations and output the ordered visualizations as ordered recommendations 84. That is, scoring/recommender system 82 may determine a score for each visualization, determine an ordering of the visualizations based on the scores, and output the visualizations in accordance with the ordering.

By determining possible visualizations of input data and comparing the possible visualizations to visual patterns and/or determining which possible visualizations relate to defined focus areas, techniques of the present disclosure may significantly reduce the difficulty in finding interesting visualizations for generating reports from input data. Furthermore, by scoring the possible visualizations based on the comparisons to the visual patterns and/or association with the focus areas, and outputting the visualizations in accordance with an order determined from the scores, the techniques described herein may increase the ease with which a user can select desired visualizations by providing a plurality of recommended visualizations in an ordered fashion.

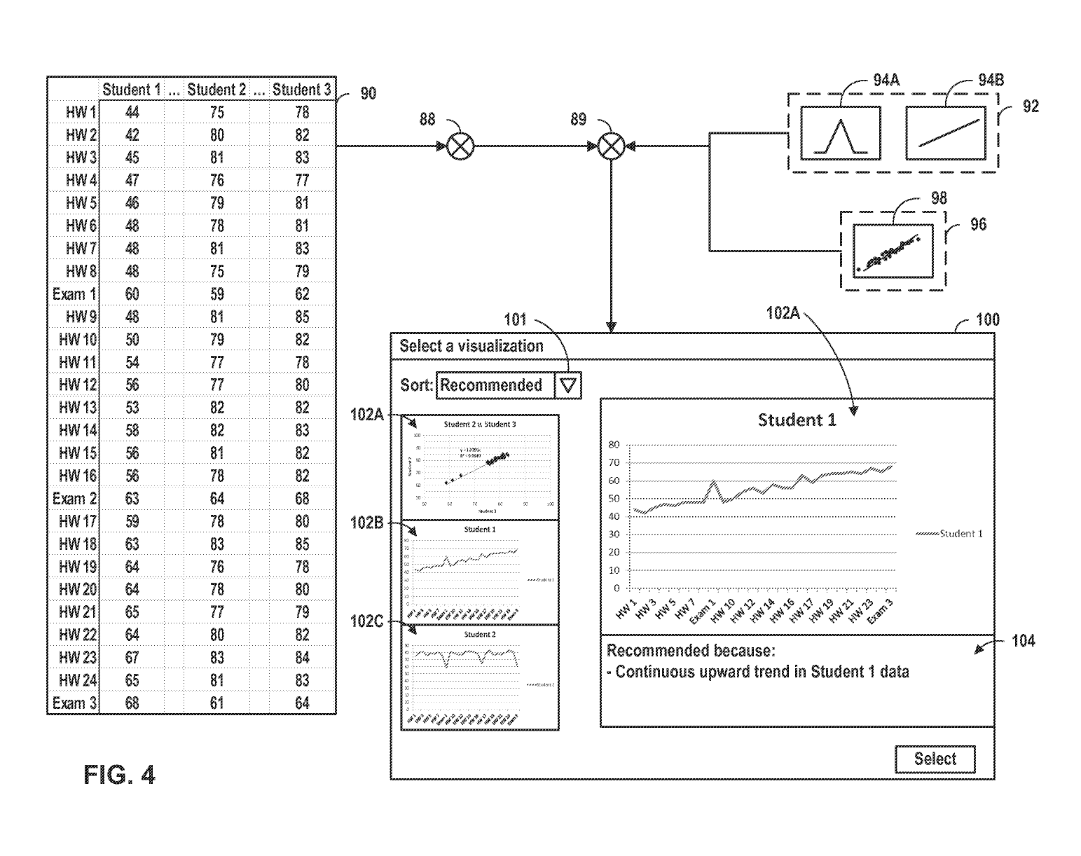

FIG. 4 is a block diagram illustrating operations and GUI 100 for providing ordered recommendations based on visual patterns, in accordance with one or more aspects of the present disclosure. For purposes of illustration only, FIG. 4 is described below is described within the context of FIGS. 1 and 2. For example, operations described in FIG. 4 may be performed by analysis recommendation module 30 of computing device 16A. The example of FIG. 4 may represent the techniques described herein within the context of academic grading software, such as software used by teachers or professors to record and monitor the performance of students.

The example of FIG. 4 includes input data 90, pattern library 92, user preferences 96, and GUI 100. In accordance with the techniques of the present disclosure, analysis recommendation module 30 may perform operations (e.g., operations 88 and 89) to compare visualizations of input data 90 to visual patterns stored within pattern library 92 and/or user preferences 96. Based on the results of the performed operations, computing device 16A may output GUI 100 for display (e.g., at a display device).

Input data 90, as shown in the example of FIG. 4, represents three sets of grading data specifying grading results for a number of homework assignments and exams. Each set of grading results may correspond to a student. While only three students are included in input data 90, input data may, in other examples, include more or fewer students. That is, techniques of the present disclosure may perform in a similar fashion on input data ranging from a few data elements to thousands of elements, millions of elements, or more.

In the example of FIG. 4, pattern library 92 contains pre-defined patterns 94A and 94B (collectively, “pre-defined patterns 94”). Pre-defined pattern 94A may be a pattern that includes a “spike” in visualized data. For instance, pre-defined pattern 94A may be a line graph that includes data having a relatively sharp increase in value followed by a relatively sharp decrease in value. Pre-defined pattern 94A may be useful to find visualizations that include a sudden or abnormal increase in a value, followed by a return to normalcy. In the example of student grades, for instance, pre-defined pattern 94A may help a teacher to find abnormal results in students' performance. Pre-defined pattern 94B may be a pattern that includes a general upward trend in visualized data. For instance, pre-defined pattern 94B may be a line graph that includes data having a continuously increasing value. Pre-defined pattern 94B may be useful to find visualizations that include a general upward trend, such as finding students whose performance has generally increased over the course of a semester.

User preferences 96, in the example of FIG. 4, contains user-defined pattern 98. User-defined pattern 98 may be a pattern that was provided by a user of computing device 16A or an administrator of enterprise business intelligence system 14. That is, a user may have created user-defined pattern 98 to be used by analysis recommendation module 30. As one non-limiting example, user-defined pattern 98 may be a scatter plot that includes plot points that generally fall along a trend line, such as the trend line y=x. In such example, user-defined pattern 98 may be useful to find visualizations that show two different categories of data that have generally the same values. For instance, user-defined pattern 98 may be visually similar to a scatter plot of one student's grades compared to another student's grades, when both students received the same grades on the same assignments. As such, a teacher or professor may create user-defined pattern 98 to show potential cheating.

In some examples, pre-defined patterns 94 and/or user-defined pattern 98 may apply only to a particular type of visualization, such as line graphs. In other examples, pre-defined patterns 94 and/or user-defined pattern 98 may apply to two or more types of visualizations, such as bar graphs, stack charts, or all possible visualization types.

In accordance with the techniques described herein, analysis recommendation module 30 may receive input data 90 and perform operation 88 to determine one or more possible visualizations. For instance, operation 88 may produce data representing a line graph visualization plotting the grades of a student for each assignment, a scatter plot visualization plotting one student's grades for each assignment versus another student's grades for the assignments, a bar chart visualization showing the average grade of all students on each assignment, or other possible visualizations.

After determining possible visualizations, analysis recommendation module 30 may perform operation 89 to compare each possible visualization to each of pre-defined patterns 94 and/or user-defined pattern 98 in order to determine similarity values, and calculate a score for each possible visualization based on the similarity values. Analysis recommendation module 30 may use the results of operation 89 (e.g., the determined scores) to generate and output GUI 100 for display (e.g., at one of output devices 36).

GUI 100 represents only one example of outputting ordered visualizations for display, and various other methods of outputting the ordered visualizations may be used in accordance with the present disclosure. GUI 100 may provide a user of computing device 16A with the ability to review recommended visualizations, and select a visualization to use in reports 17. As shown in the example of FIG. 4, GUI includes sort option 101, ordered visualizations 102A-102C (collectively, “ordered visualizations 102”), and information box 104.

Ordered visualizations 102 represent the outputted possible visualizations ordered in accordance with the results of operation 89. That is, ordered visualizations 102 may be ordered based on the score of each visualization after comparing the visualization to pre-defined patterns 94 and/or user-defined pattern 98. As such, ordered visualization 102A may be the visualization that is most recommended, ordered visualization 102B may be the visualization that is second-most recommended, and so on. For instance, ordered visualization 102A may be most recommended because it received a high similarity value for user-defined pattern 98. Ordered visualization 102B may be recommended because it received a high similarity value for pre-defined pattern 94A and/or pre-defined pattern 94A. Ordered visualization 102C may be less recommended because it does not have a high similarity values for any of pre-defined patterns 94 or user-defined pattern 98.

In some examples, possible visualizations that correspond to high similarity values for user-defined patterns may be ordered higher than possible visualizations that correspond to high similarity values for pre-defined patterns. That is, in some examples, analysis recommendation module 30 may order visualizations matching user-defined patterns above visualizations matching pre-defined patterns. In other examples, analysis recommendation module 30 may not differentiate between pre-defined patterns and user-defined patterns.

In some examples, operation 89 may additionally or alternatively include comparing possible visualizations to one or more focus areas. That is, for instance, in addition to comparing possible visualizations to pre-defined patterns 94 and/or user-defined pattern 98, analysis recommendation module 30 may also determine whether or not the possible visualizations depict measures included in a pre-defined or user-defined focus area.

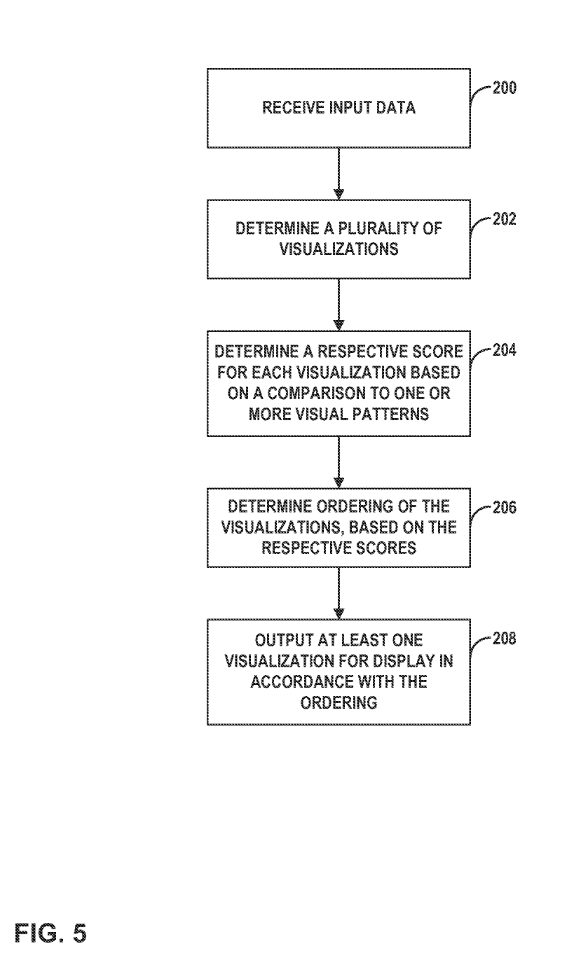

FIG. 5 is a flowchart illustrating example operations of a computing device for providing recommendations based on visual patterns, in accordance with one or more aspects of the present disclosure. For purposes of illustration only, the example operations of FIG. 5 are described below within the context of FIGS. 1 and 2.

In the example of FIG. 5, computing device 16A may receive input data (200). Based at least in part on the input data, computing device 16A (e.g., analysis recommendation module 30) may determine a plurality of visualizations (202). Each of the plurality of visualizations may represent at least a portion of the input data. Computing device 16A may determine a respective score for each of the plurality of visualizations (204). The respective score for each visualization may be based at least in part on a comparison of the corresponding visualization to one or more visual patterns. Based at least in part on the respective score for each of the plurality of visualizations, computing device 16A may determine an ordering of the plurality of visualizations (206). Computing device 16A may output at least one visualization from the plurality of visualizations for display, in accordance with the ordering (208).

In some examples, each visualization from the plurality of visualizations comprises a set of data defining the corresponding visualization, and each visual pattern from the one or more visual patterns comprises a set of data defining the corresponding visual pattern. In some examples, a visual pattern from the one or more visual patterns comprises a user-defined visual pattern. In some examples, determining the ordering of the plurality of visualizations comprises: determining a first ordering of a first group of visualizations from the plurality of visualizations, wherein each visualization from the first group of visualizations has a respective similarity to the user-defined visual pattern that exceeds a defined similarity threshold; and determining a second ordering of a second group of visualizations from the plurality of visualizations, wherein each visualization from the second group of visualizations does not have a respective similarity to the user-defined visual pattern that exceeds the defined similarity threshold.

In some examples, determining the respective score for each of the plurality of visualizations comprises determining the respective score for each of the plurality of visualizations based on at least one focus area, the at least one focus area defining one or more data measures. In some examples, the at least one focus area comprises a user-defined focus area. In some examples, determining the respective score for each of the plurality of visualizations comprises: sending, by the computing device, one or more requests to compare the corresponding visualization to each visual pattern from the one or more visual patterns; responsive to sending the one or more requests, receiving, by the computing device, one or more sub-scores representing a similarity between the corresponding visualization and each visual pattern from the one or more visual patterns; and determining the respective score for the corresponding visualization based at least in part on the one or more sub-scores.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various examples have been described. These and other examples are within the scope of the following claims.

What is claimed is:

1. A method comprising:
receiving, by a computing device comprising at least one processor, input data;
determining, by the computing device and based at least in part on the input data, a plurality of visualizations, each of the plurality of visualizations representing at least a portion of the input data;
determining, by the computing device, a respective score for each of the plurality of visualizations, the respective score for each visualization from the plurality of visualizations being based at least in part on a comparison of the corresponding visualization to one or more visual patterns;
determining, by the computing device and based at least in part on the respective score for each of the plurality of visualizations, an ordering of the plurality of visualizations; and
outputting, by the computing device and for display, at least one visualization from the plurality of visualizations in accordance with the ordering.

2. The method of claim 1,
wherein each visualization from the plurality of visualizations comprises a set of data defining the corresponding visualization, and
wherein each visual pattern from the one or more visual patterns comprises a set of data defining the corresponding visual pattern.

3. The method of claim 1, wherein a visual pattern from the one or more visual patterns comprises a user-defined visual pattern.

4. The method of claim 3, wherein determining the ordering of the plurality of visualizations comprises:
determining a first ordering of a first group of visualizations from the plurality of visualizations, wherein each visualization from the first group of visualizations has a respective similarity to the user-defined visual pattern that exceeds a defined similarity threshold; and
determining a second ordering of a second group of visualizations from the plurality of visualizations, wherein each visualization from the second group of visualizations does not have a respective similarity to the user-defined visual pattern that exceeds the defined similarity threshold.

5. The method of claim 1, wherein determining the respective score for each of the plurality of visualizations comprises determining the respective score for each of the plurality of visualizations based on at least one focus area, the at least one focus area defining one or more data measures.

6. The method of claim 5, wherein the at least one focus area comprises a user-defined focus area.

7. The method of claim 1, wherein determining the respective score for each of the plurality of visualizations comprises:
sending, by the computing device, one or more requests to compare the corresponding visualization to each visual pattern from the one or more visual patterns;
responsive to sending the one or more requests, receiving, by the computing device, one or more sub-scores representing a similarity between the corresponding visualization and each visual pattern from the one or more visual patterns; and
determining the respective score for the corresponding visualization based at least in part on the one or more sub-scores.

8. A computing system comprising:
at least one processor; and
at least one module operable by the at least one processor to:
receive input data;
determine, based at least in part on the input data, a plurality of visualizations, each of the plurality of visualizations representing at least a portion of the input data;
determine a respective score for each of the plurality of visualizations, the respective score for each visualization from the plurality of visualizations being based at least in part on a comparison of the corresponding visualization to one or more visual patterns;
determine, based at least in part on the respective score for each of the plurality of visualizations, an ordering of the plurality of visualizations; and
output, for display, at least one visualization from the plurality of visualizations in accordance with the ordering.

9. The computing system of claim 8,
wherein each visualization from the plurality of visualizations comprises a set of data defining the corresponding visualization, and
wherein each visual pattern from the one or more visual patterns comprises a set of data defining the corresponding visual pattern.

10. The computing system of claim 8, wherein a visual pattern from the one or more visual patterns comprises a user-defined visual pattern.

11. The computing system of claim 10, wherein the at least one module operable to determine the ordering of the plurality of visualizations is operable, by the at least one processor, to:
determine a first ordering of a first group of visualizations from the plurality of visualizations, wherein each visualization from the first group of visualizations has a respective similarity to the user-defined visual pattern that exceeds a defined similarity threshold; and
determine a second ordering of a second group of visualizations from the plurality of visualizations, wherein each visualization from the second group of visualizations does not have a respective similarity to the user-defined visual pattern that exceeds the defined similarity threshold.

12. The computing system of claim 8, wherein the at least one module operable to determine the respective score for each of the plurality of visualizations is operable, by the at least one processor, to determine the respective score for each of the plurality of visualizations based on at least one focus area, the at least one focus area defining one or more data measures.

13. The computing system of claim 12, wherein the at least one focus area comprises a user-defined focus area.

14. The computing system of claim 8, wherein the at least one module operable to determine the respective score for each of the plurality of visualizations is operable, by the at least one processor, to:
send one or more requests to compare the corresponding visualization to each visual pattern from the one or more visual patterns;
responsive to sending the one or more requests, receive one or more sub-scores representing a similarity between the corresponding visualization and each visual pattern from the one or more visual patterns; and
determine the respective score for the corresponding visualization based at least in part on the one or more sub-scores.

15. A computer program product comprising a computer readable storage medium having program code embodied therewith, the program code executable by at least one processor to:
receive input data;
determine, based at least in part on the input data, a plurality of visualizations, each of the plurality of visualizations representing at least a portion of the input data;
determine a respective score for each of the plurality of visualizations, the respective score for each visualization from the plurality of visualizations being based at least in part on a comparison of the corresponding visualization to one or more visual patterns;
determine, based at least in part on the respective score for each of the plurality of visualizations, an ordering of the plurality of visualizations; and
output, for display, at least one visualization from the plurality of visualizations in accordance with the ordering.

16. The computer program product of claim 15,
wherein each visualization from the plurality of visualizations comprises a set of data defining the corresponding visualization, and
wherein each visual pattern from the one or more visual patterns comprises a set of data defining the corresponding visual pattern.

17. The computer program product of claim 15, wherein a visual pattern from the one or more visual patterns comprises a user-defined visual pattern.

18. The computer program product of claim 17, wherein the program code executable by the at least one processor to determine the ordering of the plurality of visualizations comprises program code executable by the at least one processor to:
determine a first ordering of a first group of visualizations from the plurality of visualizations, wherein each visualization from the first group of visualizations has a respective similarity to the user-defined visual pattern that exceeds a defined similarity threshold; and
determine a second ordering of a second group of visualizations from the plurality of visualizations, wherein each visualization from the second group of visualizations does not have a respective similarity to the user-defined visual pattern that exceeds the defined similarity threshold.

19. The computer program product of claim 15, wherein the program code executable by the at least one processor to determine the respective score for each of the plurality of visualizations comprises program code executable by the at least one processor to determine the respective score for each of the plurality of visualizations based on at least one focus area, the at least one focus area defining one or more data measures.

20. The computer program product of claim 19, wherein the at least one focus area comprises a user-defined focus area.
